(19) United States
(12) Patent Application Publication
(10) Pub. No.: US 2010/0146761 A1
(43) Pub. Date: Jun. 17, 2010

(54) DISASSEMBLY OF BATTERY

(76) Inventor: Steven E. Sloop, Bend, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/639,912

(22) Filed: Dec. 16, 2009

Related U.S. Application Data
(60) Provisional application No. 61/138,224, filed on Dec. 17, 2008.

(51) Int. Cl. H01M 10/54

(52) U.S. Cl. 29/403.3; 29/426.2

(57) ABSTRACT

Embodiments related to processing spent energy storage and conversion devices for recycling are disclosed. For example, one disclosed embodiment provides a method comprising obtaining a spent energy storage and conversion device that includes packaging containing one or more cells, opening the packaging of the spent energy storage and conversion device to expose at least a portion of the one or more cells of the spent energy storage and conversion device, discharging the one or more cells of the spent energy storage and conversion device, separating the one or more cells from the packaging to yield one or more individual cells, disassembling each cell in the one or more individual cells, where disassembling each cell comprises cutting the container of the cell, separating the container from the plurality of cell components; and separating the positive and negative electrode materials.

### CROSS REFERENCE TO RELATED APPLICATION

This application claims priority from U.S. Provisional Patent Application Ser. No. 61/138,224, filed on Dec. 17, 2008 and entitled DISASSEMBLY OF BATTERY, the entirety of which is hereby incorporated herein by reference for all purposes.

### TECHNICAL FIELD

The present application relates to the field of used battery processing.

### BACKGROUND

Energy storage and conversion devices are used in a variety of consumer products such as portable electronic devices and electric vehicles, for example. Examples of such devices include supercapacitors, ultracapacitors, and various types of batteries, battery packs, or modules containing one or more energy storage cells. Further, energy storage and conversion devices include primary (non-rechargeable) and secondary (rechargeable) batteries incorporating various wet or dry cells, for example. Examples of non-rechargeable batteries include zinc-carbon batteries and alkaline batteries. Examples of rechargeable batteries include lead-acid, nickel-cadmium, nickel-zinc, nickel metal hydride, and lithium-ion cells.

Energy storage and conversion devices eventually fail or are discarded prior to failure, and therefore contribute to a significant and growing waste stream. In view of this situation, environmental regulations, industry standards, and collection services have arisen to promote the recycling of energy storage and conversion devices.

Current battery recycling procedures rely on pulverizing whole battery materials, e.g., whole batteries including packaging, and utilize high temperature, high energy and/or chemically intensive processes to separate and reclaim materials for recycling. For example, such methods incinerate all combustible battery materials including packaging and melt potentially valuable metal for recycling.

For example, current recycling procedures for LiCoO₂ cells may include two general approaches, pyrometallurgy and hydrometallurgy. Pyrometallurgical (or smelting) processing utilizes high temperatures to decompose and melt materials within the lithium cells leading to the recovery of metallic cobalt, or cobalt containing alloys. Such processing techniques thus generally involve the decomposition of the LiCoO₂ battery material, and therefore require further steps to manufacture LiCoO₂ from the recovered metallic cobalt or alloys. Hydrometallurgic decomposition of lithium cells utilizes strong acids or bases and leads to the recovery of cobalt salts through multistep processing and precipitation reactions.

### SUMMARY

Accordingly, the inventor herein has recognized that an economically robust recycling or refurbishing strategy is one that preserves and enhances the value of the electrode material. In one disclosed embodiment, a method for processing spent energy storage and conversion devices for recycling, comprises obtaining a spent energy storage and conversion device that includes packaging containing one or more cells, where each cell in the one or more cells comprises a container containing a plurality of cell components, and wherein the plurality of cell components including a positive electrode material and a negative electrode material. The method further comprises disassembling the spent energy storage and conversion device by opening the packaging of the spent energy storage and conversion device to expose at least a portion of the one or more cells of the spent energy storage and conversion device; discharging the one or more cells of the spent energy storage and conversion device; separating the one or more cells from the packaging to yield one or more individual cells; disassembling each cell in the one or more individual cells, where disassembling each cell comprises cutting the container of the cell; separating the container from the plurality of cell components; and separating the positive and negative electrode materials.

Another disclosed embodiment provides a method for processing a spent energy storage and/or conversion device for recycling, wherein the method comprises obtaining a spent energy storage and/or conversion device that includes packaging containing one or more cells and circuitry connecting the one or more cells, wherein the circuitry includes a power management controller, cutting the packaging to expose at least a portion of the one or more cells, and connecting a resistor to the circuitry to bypass the power management controller to discharge the one or more cells to a nominal voltage.

Yet another disclosed embodiment provides a method for processing a spent energy storage and/or conversion device for recycling, wherein the method comprises obtaining a spent energy storage and/or conversion device that includes one or more cells, wherein each cell of the one or more cells comprises a container containing a plurality of cell components and wherein the container is formed at least partially from a ferromagnetic material and for each cell of the one or more cells, cutting the container of the cell and magnetically separating the container from the plurality of cell components.

It will be understood that the Summary above is provided to introduce in simplified form a selection of concepts that are further described in the detailed description, which follows. It is not meant to identify key or essential features of the claimed subject matter, the scope of which is defined by the claims that follow the detailed description. Further, the claimed subject matter is not limited to implementations that solve any disadvantages noted above or in any part of this disclosure.

### BRIEF DESCRIPTION OF THE DRAWINGS

FIG. 1 shows a schematic diagram of an example embodiment of an energy storage and conversion device.

FIG. 2 shows an illustration of an example embodiment of a cell.

FIG. 3 shows an example embodiment of a method for processing a plurality of spent energy storage and conversion devices for recycling.

FIG. 4 shows an example embodiment of a method for disassembling a spent energy storage and conversion device into a plurality of individual cells for recycling.

FIG. 5 shows an example embodiment of a method for disassembling a cell for recycling.

FIG. 6 shows a circuit diagram illustrating an embodiment of a method of discharging an energy storage and conversion device.

FIGS. 7A and 7B show example cutting lines illustrating embodiments of methods of cutting a cell open.

FIG. 8 shows a schematic diagram of an embodiment of an apparatus for magnetically separating a container of a cell from the cell components after opening the container.

FIG. 9 illustrates an unwinding of positive and negative electrode materials with a spindle according to an embodiment of the present disclosure.

FIG. 10 shows a table comparing results of different recycling methods.

### DETAILED DESCRIPTION

Embodiments are disclosed herein that are related to the disassembly of energy storage and conversion devices during recycling. The inventor herein has recognized that current energy storage and conversion device recycling approaches, which pulverize, shred, melt or dissolve whole energy storage and conversion devices to recover valuable elements as described above, may cause cross-contamination of the constituent components of such a device, and therefore render the components less useful as recycled materials. For example, copper, iron and other metals may contaminate the LiCoO2 electrode when such processes are applied to lithium-ion devices.

Additionally, the inventor herein has recognized that shredding or pulverizing whole energy storage and conversion devices may cause the encapsulation of materials during recycling. Such encapsulation may require additional equipment, such as a granulator, to separate, and may therefore compounds the contamination problem, as encapsulated materials require more equipment, processing and cost to retrieve than disassembled parts. Further, relatively high fractions (e.g., 50% by weight) of recycled material in new product content cannot be met by current recycling processes.

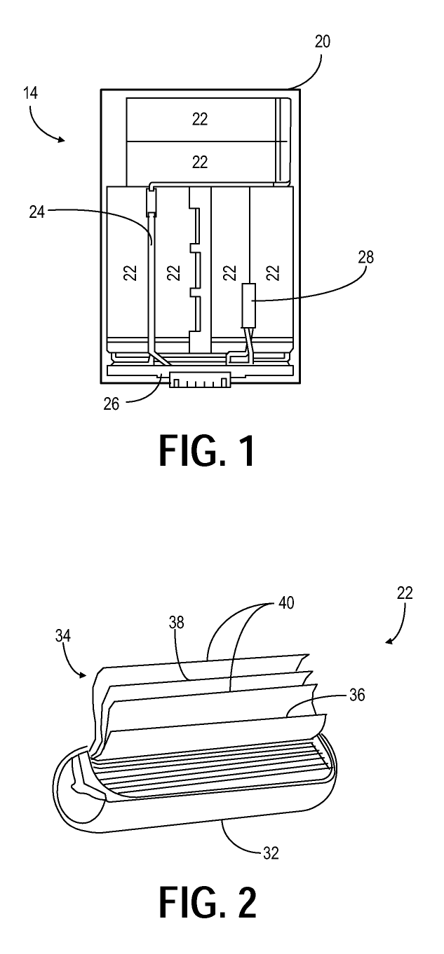

FIG. 1 shows a schematic diagram illustrating an example embodiment of an energy storage and conversion device 10. Device 10 includes packaging 20, sometimes referred to as a module, containing a plurality of energy storage cells 22. The packaging may be made of a variety of materials, including but not limited to one or more plastics, metals, or combinations thereof. The packaging serves to protect and hold the energy storage cells and other components of the energy storage and conversion device, and also to connect the cells to a device, such as a laptop computer, portable device, etc. powered by the cells. For example, the packaging may include metal tabs 30 to hold the cells 22 in place. Further, the cells may be spot welded to the packaging.

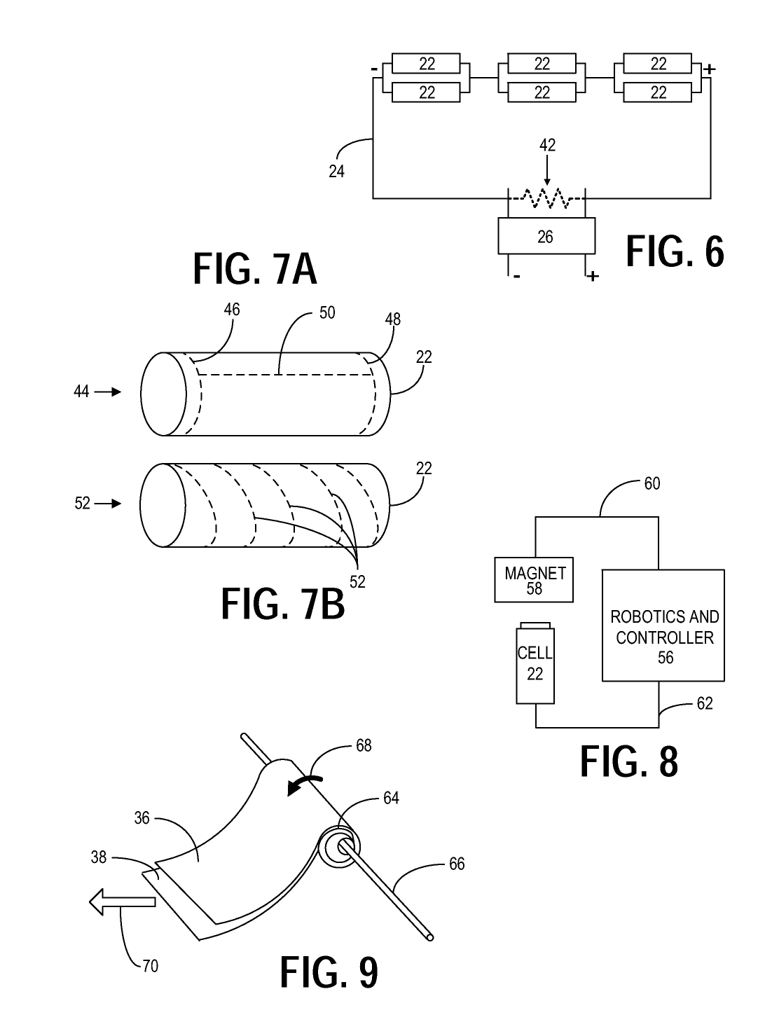

Device 10 further includes circuitry 24 connecting the plurality of cells. In the example shown in FIG. 1, device 10 includes six cells 22. In the depicted embodiment, the six cells in device 10 are grouped in cell pairs, where each cell pair is connected in parallel and each of the three cell pairs is connected in series. FIG. 6, described in detail below, shows a circuit diagram for the circuitry of device 10.

The circuitry in device 10 further includes a power management controller 26, shown here schematically as a circuit board positioned between the cells 22 and a connector for connecting the battery to a device powered by the. Power management controller 26 may prevent device 10 from discharging past a minimum voltage (that may not fully discharged) or charging above a maximum voltage, for example. In general, power management controller 26 may monitor various components of device 10 in order to protect and manage the performance of device 10. For example the circuitry 24 may include a temperature sensor 28 which the power management controller may use to prevent device 10 from overheating, and also may prevent the battery from either overdischarging or overcharging.

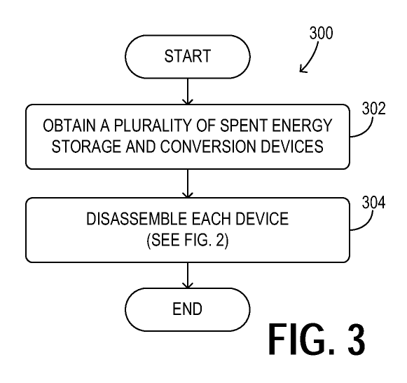

The cells 22 in device 10 may be of various types, sizes, and shapes. In one example, they may be cylindrically-shaped energy storage cells, an example of which is illustrated in FIG. 2. Cell 22 comprises a container 32 containing a plurality of cell components indicated generally at 34. The container may comprise a variety of different materials. In some examples, the container may be formed at least partially from a ferromagnetic material, such as iron. In other examples, the container may be formed of aluminum, plastic materials, combinations of such materials, etc.

The plurality of cell components 34 may include a variety of different components depending on the type of cell. Generally, the plurality of cell components includes a positive electrode material 36 and a negative electrode material 38. For example, in some lithium ion cells, the positive electrode material may include one or more of LiCoO₂, LiFePO₄, or LiMn₂O₄, and the negative electrode material may include lithium intercalated graphite.

As illustrated in FIG. 2, the positive and negative electrode materials may be layered (e.g. rolled) and separated by porous separator material 40 that houses electrolyte. Further, the electrode materials may be wound together into a wound or spiral structure within the cell.

The plurality of cell components 34 may further include current collector material attached or laminated to the electrode materials. The current collector material may be formed at least partially from a conductive material, such as copper, aluminum, etc. The plurality of cell components may further include a variety of other components such as insulators, electrode tabs, various gaskets, etc.

As described above, cross-contamination of spent energy storage and conversion device components during recycling may be reduced by disassembly of spent energy storage and conversion device prior to chemical and/or physical separation processes to recover materials for recycling. Further, partly-automated or fully-automated disassembly of a spent energy storage and conversion device may further improve recycling efficiency.

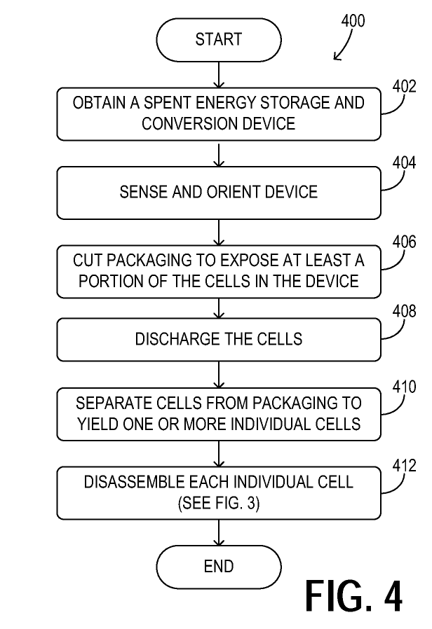

FIG. 3 shows an example embodiment of a method 300 for processing spent energy storage and conversion devices for recycling by disassembling the packaging and cells of spent energy storage and conversion devices. In some embodiments, the disassembly may be combined with soft chemical techniques, such as a carbon dioxide extraction, to further reduce opportunities for cross-contamination.

At 302, method 300 includes obtaining a plurality of spent energy storage and conversion devices. Spent energy storage and conversion devices may be obtained from a variety of sources and by a variety of methods. Further, obtaining a plurality of spent energy storage and conversion devices may include one or more harvesting, preparation, treatment and/or processing steps.

For example, a plurality of spent energy storage and conversion devices may be obtained from a recycling or waste stream. The recycling or waste stream from which the plurality of spent energy storage and conversion devices is obtained may be a dedicated battery recycling or waste stream. Further, the plurality of spent energy storage and conversion devices may be obtained from the waste or recycling stream in any suitable manner.

As described above with regard to the example energy storage and conversion device shown in FIG. 1, each spent energy storage and conversion device in the plurality of spent energy storage and conversion devices may include packaging containing one or more cells. For example, the devices may include computer battery packs, prismatic cells, HEV (hybrid electric vehicle) packs, etc. Each cell in the one or more cells may comprise a container containing a plurality of cell components, where the plurality of cell components includes a positive electrode material and a negative electrode material.

At 304, method 300 includes disassembling each spent energy and conversion device in the plurality of spent energy storage and conversion devices. The disassembly of each spent energy and conversion device in the plurality of spent energy storage and conversion devices may be carried out in any suitable manner. For example, one or more steps of the disassembly may be performed manually or by various types of processing equipment. One example embodiment of a method of disassembling each spent energy storage and conversion device is shown in FIG. 4.

FIG. 4 shows an example embodiment of a method 400 for disassembling a spent energy storage and conversion device for recycling.

At 402, method 400 includes obtaining a spent energy storage and conversion device, and, at 404, sensing and orienting the spent energy storage and conversion device. For example, processing equipment may be configured to electronically sense an orientation of the spent energy storage and conversion device and reorient the device if it is not oriented in a suitable orientation for disassembly.

Process 404 may further include identifying information about the spent energy storage and conversion device. A spent energy storage and conversion device may be identified by a variety of methods. For example, the spent energy storage and conversion device may be placed in an optical scanner to scan barcodes or other optical tags on the packaging of the device to identify shape and type of cell, etc. In other examples, the dimensions of the spent energy storage and conversion device may be determined and compared to dimensions of known devices. In still other examples, the spent energy storage and conversion device may be weighed. Further, packaging of the device may be read and/or optically scanned for identification of chemistry present in the device. In some examples, a part number protocol for processing the device may be developed based on identification of the types of devices in the plurality of spent energy storage and conversion devices, for example. Additionally, any combination of these or other methods may be used.

At 406, method 400 includes opening the packaging of the spent energy storage and conversion device to expose at least a portion of the one or more cells of the device. For example, the package of the device may be cut open with a blade, mill, laser, high pressure milling device or the like, in order to expose one or more cells and/or the circuitry of the device. In some examples, opening the packaging to expose at least a portion of the one or more cells may comprise cutting via one or more multi-axis CNC devices, based on computer aided design software (CAD) drawings of the packaging and cells, for example.

At 408, method 400 includes discharging the one or more cells of the spent energy storage and conversion device. Discharging the one or more cells of the spent energy storage and conversion device may be performed by a variety of methods. For example, the one or more cells may be discharged by submerging the cells in a salt solution or by using a liquid or supercritical CO₂ solution.

In other examples, full discharge of the energy storage and conversion device may be performed by connecting a resistor to the circuitry of the device. As described above, the circuitry of the spent energy storage and conversion device may include a power management controller which prevents the device from fully discharging. In such a scenario, a resistor may be connected to the circuitry at such a location as to bypass the power management controller to fully discharge the one or more cells of the spent energy storage and conversion device. For example, FIG. 6 shows a circuit diagram for an energy storage and conversion device with a plurality of cells 22 and a power management controller 26. In FIG. 6, a resistor 42 is shown connected to the circuitry 24 at a location which bypasses the power management controller 26 in order to fully discharge the cells 22.

Discharging the one or more cells of the spent energy storage and conversion device may include discharging the one or more cells to a predetermined nominal voltage, e.g., less than one volt. In this way, safety of disassembling the device may be improved. Furthermore, discharging the cells in the device using a resistor rather than through chemical means, such as a salt solution, further reduces opportunities for contamination of the materials in the device.

At 408, method 400 includes separating the one or more cells from the packaging to yield one or more individual cells by cutting the interconnecting devices holding the cells within the packaging. For example, separating the one or more cells from the packaging to yield one or more individual cells may include using a blade to cut one or more bindings that holds the cells together or attaches the cells to the packaging. For example, cells may be strapped together in pairs (such as shown in FIG. 1) with sheet metal pieces and/or spot welding and a blade may be used to unfasten these connections. Further, cutting the interconnecting devices holding the cells within the packaging may be performed by one or more multi-axis CNC devices based on CAD drawings of the spent energy storage and conversion device, for example. In other embodiments, any other suitable cutting device, such as a laser cutting device, may be used.

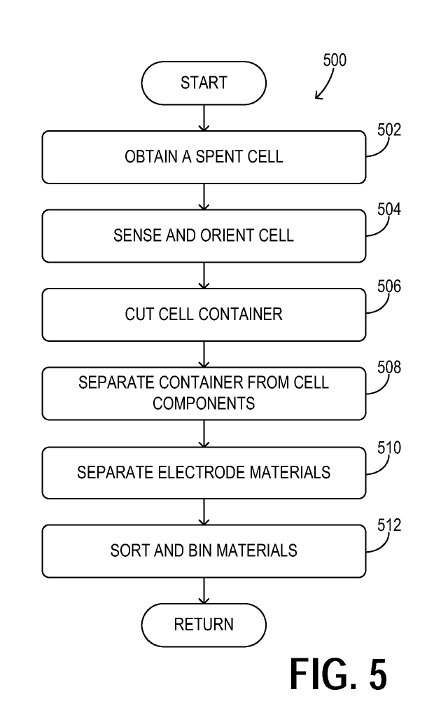

At 412, method 400 includes disassembling each cell in the one or more individual cells of the spent energy storage and conversion device. The disassembly of each cell in the one or more individual cells of the spent energy storage and conversion device may be carried out in any suitable manner. For example, one or more steps of the cell disassembly may be performed manually or by various types of processing equipment. One example embodiment of a method of disassembling each cell in the one or more individual cells of the spent energy storage and conversion device is shown in FIG. 5.

FIG. 5 shows an example embodiment of a method 500 for disassembling a cell for recycling by removing the container of the cell and disassembling the various components of the cell. At 502, method 500 includes obtaining a spent cell and at 504, sensing and orienting the cell. For example, processing equipment may be configured to electronically sense an orientation of the spent cell and reorient the cell if it is not oriented in a suitable orientation for disassembly.

Step 504 of method 500 may further include identifying information about the spent cell. For example, shape, size, and type of the cell may be identified by a variety of methods. For example, the cell may be placed in an optical scanner to scan barcodes or other optical tags or color on the container of the cell to identify shape and type of cell, etc. In other examples, the dimensions of the cell may be determined, e.g., through various measurements. In still other examples, the cell may be weighed, and/or various combinations of these and/or other methods may be employed Further, in some examples, a protocol for processing the cell may be developed based on identification of the type of cell, for example.

At 506, method 500 includes cutting the container of the cell. The container may be cut by a variety of methods. For example, the container may be cut by a saw, laser, jet, lathe, and/or multi-axis CNC device. In one example, a CNC may be programmed to open the container of the cell. Various numbers and types of cuts may be employed in cutting the container of the cell.

A cell container may be cut in any suitable location. For example, as illustrated in FIG. 7A at 44, a cylindrically-shaped cell 22 may be cut along diameter portions 46 and 48 of opposing ends of the container and along a slit 50 along a length of the container. In another example, as illustrated in FIG. 7B at 52, a cylindrically-shaped cell 22 may be cut by a lathe, e.g., a bar-feed lathe. Example lathe cuts are shown at 52 in FIG. 7. Such a lathe may allow removal of a cylindrical cell container by rotating the cell into a blade. The bar feed may include a spindle inserted down the middle of the cell on which the cell would be fed. The spindle further could provide the torque to rotate the cell, and/or the cell could be rotated from the surface of the cylinder.

At 508, method 500 includes separating the container from the plurality of cell components. The cuts in the container performed in step 506 may assist with removal of the cell components from the container.

In some examples, the cell components may be pushed out of the container by one or more methods. Additionally, spring tension may be present in the cell container and may be used to assist with the separation of the cell components from the container. For example, the cell container may pop open to at least some degree after the container is cut, thereby simplifying removal of the cell components from the container. In other examples, a motion control process may be used to clamp, secure, and/or hook one or more of the cell components to allow for mechanical separation of the container from the cell components.

After the cell is opened, the cell components may be removed from the cell in any suitable manner. For example, in some cases, the container of the cell may be formed at least partially from a ferromagnetic material, e.g., iron. In such a scenario, separating the container from the plurality of cell components may include magnetically separating the container from the plurality of cell components. FIG. 8 shows an example schematic diagram of such a separating machine. A robotics and controller device 56 is shown coupled to a magnet device 58 and a cell 22. For example, the cell 22 may be positioned and oriented by a robotic arm or other assembly device 62 for magnetic removal of the cell container. Additionally, a robotic arm 60 may be used to position and orient magnetic device 58 for removal of the container. In other embodiments, the magnetic device 58 may be stationary and a holder of the cell 22 may move to allow magnetic separation. In either case, magnetic separation of ferromagnetic materials such as iron may help to reduce contamination of components. For example, this may help to decrease the presence of iron, nickel, and other such contaminants in a recycled material compared to recycling methods that utilize grinding, smelting, and/or other such methods in which all of components of an energy storage and conversion device are processed together. In experiments comparing purity of recovered product (lithium cobalt oxide) from disassembled vs. ground samples, the contamination levels observed were as follows: (disassembled:ground) iron 30.8 ppm:126 ppm; chromium 0.023 ppm:4.3 ppm; nickel 6.9 ppm:19.5 ppm; and zinc 0.29 ppm:0.48 ppm.

The observed recovered material contamination levels are thus lower for disassembled cells in comparison with ground/shredded cells.

At 510, method 500 includes separating the positive electrode material and the negative electrode material from the plurality of cell components. In some examples, separating the positive electrode material and the negative electrode material from the plurality of cell components may be performed before removing the container from the plurality of cell components. Further, separating the electrode material from the cell components may be performed by a variety of methods depending on the type cell.

In some examples, the positive electrode material and the negative electrode material may be manufactured into a wound or spiral structure, such as shown in the example cell illustrated in FIG. 2. In such a scenario, the electrode material may be unwound by a variety of methods. One example of unwinding electrode material is illustrated in FIG. 9.

FIG. 9 shows an illustration of separating the electrode material from the cell components by inserting a spindle 66 (or similar device) into the center of a wound structure 64 of a cell. In some examples, the spindle may be a component of a current collector providing a fastening joint to assist with physical separation of the electrode material.

The cell components may then be rotated, for example in a direction as indicated by arrow 68, in order to unravel the wound electrode materials. Upon rotation, the positive electrode material 36 and the negative electrode material 38 will unwind in a direction indicated by arrow 70. Further, the positive electrode material 36 and the negative electrode material 38 may separate during the rotation.

In other examples, separating the positive and negative electrode material from the cell includes unwinding the positive and negative electrode material by mechanically agitating the positive and negative electrode material. Mechanical agitation may be performed in a variety of ways using a variety of devices. For, example the electrode material may be separated by agitation in a rotary agitator device similar in action to a cement mixer.

In some examples, the plurality of cell components of each cell includes a current collector material connected to the electrode material. The current collector material may be formed at least partially from a conductive material such as copper or aluminum, for example and may include material connected to the negative electrode material and material connected to the positive electrode material. The current collector material may be separated from the positive and negative electrode materials in any suitable manner, for example, by delaminating or peeling the current collector material off of the electrode materials. In some examples, the electrode materials may be at least partially in a powdered form and may be delaminated from the current collector material with water in an ultrasonic bath.

The plurality of cell components further may include an electrolyte, for example any suitable salt material. In this case, the electrolytes may be extracted from the plurality of cell components. Extracting and recovering the electrolytes may increase the percentage of material recovery during recycling. For example, various treatments such as carbon dioxide (liquid, supercritical, etc.) or other extraction fluids may be employed to remove electrolytes and/or unwanted waste products from the electrode materials. Additionally, appropriate cleaning routines may be employed to remove dirt, moisture, oil, etc., for example via an alcohol rinse or other suitable solvent treatment.

Methods 300, 400, and 500 may further include additional steps to passivate reactive material within the cells of the energy storage and conversion devices. The term ‘passivate’ is used herein to indicate reducing the chemical reactivity of a substance to make it safer to store and/or handle. For example, a form of chemical reactivity that is contemplated in the context of lithium batteries is the combustibility of the negative electrodes of lithium and lithium-ion cells. Such negative electrodes may contain lithium metal or lithium-intercalated graphite, which may react violently with water and/or may spontaneously ignite in air. These materials may be passivated by controlled chemical oxidation and/or interaction with a Lewis base, such as an alkyl carbonate or ether, or a Lewis Acid. It is noted that this manner of passivation may be applied to other battery materials as well, in addition to lithium and lithium-ion battery materials. In one example, passivating the reactive material may comprise exposing the one or more breeched cells to air and/or water in a controlled manner. In another example, passivating the reactive material may comprise bathing the one or more breeched cells in a solvent such as liquid carbon dioxide or supercritical carbon dioxide, which may or may not include a controlled amount of an oxidant such as air or water added to the carbon dioxide. In these and other examples, the controlled environment in which the breeched cells are passivated may be configured to accommodate a release of dihydrogen or other gas-phase products that may be released when the lithium-containing negative electrodes of the one or more breeched cells are passivated.

Continuing with FIG. 5, at 512, method 500 includes sorting and binning the various materials obtained in the previous disassembly steps. The positive electrode material, the negative electrode material, and the container may be sorted by any suitable method and binned for further processing of the disassembled components. For example, in some embodiments, the container of the cells may be binned during the magnetic separation of container material described above with regard to step 508 of method 500. Then, binning of the electrode material may occur following the separation positive and negative electrode material as described above with regard to step 510 of method 500. For example, a spindle may hold the negative electrode material after unwinding, so that the positive electrode material can be binned. The negative electrode material may then be removed from the spindle and binned after the binning of the positive electrode material. Binning may occur using any suitable method and apparatus. For example, binning may be performed by one or more mechanical means, blasts of air, and/or filtration steps. Further, in some examples, metals, such as aluminum, and plastics may be separated from the various components of the energy storage and conversion devices by suitable methods. For example, plastic materials may be floated out of one or more components using a suitable solvent.

Following the various disassembly steps described above, further processing steps may be performed in order to recondition materials to be re-used in energy storage and conversion devices.

For example, when the spent energy storage and conversion devices are lithium based, e.g., lithium-ion batteries, the recovered spent electrode material separated from the one or more breeched cells may include a lithium-deficient form of lithium cobalt oxide (LiCoO₂), viz., Li₁₋ₓCoO₂ where 0<x<1. Other materials may have similar lithium deficiencies. Other examples include, but are not limited to, LiTiO2, LiFePO₄, LiMnO₂, LiNi_{0.80}CO_{0.05}Al_{0.15}O₂. In this example, further processing may be performed to reinstate lithium in the lithium deficient material.

Further, some electrode materials may convert at least partially from a first crystallographic state to a second crystallographic state during use. As such, spent electrode material separated from the cells may include a portion of material in the second crystallographic state. For example, the quantity of spent electrode material may include LiCoO₂, and/or substituted/doped congeners thereof, in which at least a portion of the material is in a spinel crystallographic state, instead of in a desired hexagonal state. In other examples, the quantity of spent electrode material separated from the one or more breeched cells may include Li₂[Mn]₂O₄, LiₓFePO₄, and/or substituted/doped congeners thereof, that contains undesirable concentrations of crystallographic defects such as J-T lattice distortions. In such examples, the electrode material may be further treated to convert at least of portion of the electrode material to the first crystallographic state. For example, by directly heating the material to a threshold temperature in the range 400-900° C. or by hydrothermally heating the material to a threshold temperature in the range 90-400° C.

In some examples, the disassembled materials may be shredded, or pulverized for further processing. Various sorting and filtration techniques may then be employed to further process the shredded or pulverized disassembled electrode materials. For example, material may be sorted based on grain size, a particle size, or a structure size of the material. To this end, sieving may be applied to a material stream comprising solids. Likewise, filtration or centrifugation may be applied to a material stream comprising a liquid having suspended or entrained pieces or particles. In some examples, one or more of the materials may be rinsed with a solvent, e.g., water or carbon dioxide, and allowed to dry. For example, this action may be taken in order to free electrode material from adherent liquid electrolyte.

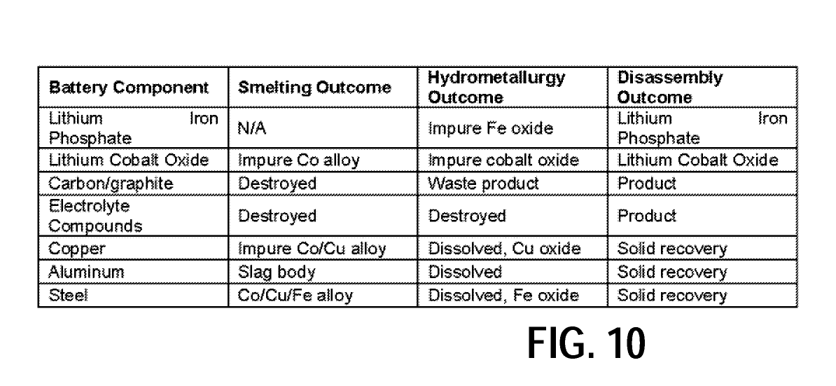

FIG. 10 shows a table comparing the automated disassembly method described above with pyrometallurgy (smelting) and hydrometallurgy recycling methods for recycling LiCoO₂ or LiFePO₄ based batteries. As described above, pyrometallurgy (smelting) and hydrometallurgy recycling methods rely on pulverizing whole battery materials, e.g., whole batteries including packaging, and utilize high temperature, high energy and/or chemically intensive processes to separate and reclaim materials for recycling. Pyrometallurgy and hydrometallurgy recycling methods may lead to contamination of recovered materials as illustrated in the table in FIG. 10. The high temperature and/or aggressive chemicals of the pyrometallurgy and hydrometallurgy recycling methods may disintegrate positive and negative electrode materials, whereas recycling with the automated disassembly method described above may lead to efficient recovery whole materials and reduces contamination. The automated disassembly technology described above may be independent of battery chemistry and may provide cost savings in manufacturing over the use of primary material. Further, automated disassembly improves the efficiency of material recovery by avoiding cross contamination of the packaging and electrodes.

In this way, efficient automated disassembly of energy storage and conversion device components independent of the chemistry may be performed. Such automated disassembly may improve product purity and quality and the potential for recycled material utilization in new products. Further, recycling efficiency and safety may be improved and sources of contamination and encapsulation may be reduced, thus circumventing potentially costly purification steps to reclaim material for the battery market.

It should be understood that one or more process of the methods described above may be wholly or partly automated, and that the methods may be repeated for any desired number of spent energy storage and conversion devices. Further, it should be understood that the example methods may be part of a more extensive method for recycling batteries and/or processing waste streams that include battery-derived wastes. Further, the example methods may be part of a more extensive method for recycling energy storage and conversion devices electrode or for making an energy storage and conversion device. Accordingly, in some examples, one or more actions may be taken prior to the first illustrated steps, and one or more actions may follow the final illustrated steps.

It will be further understood that some of the process steps described and/or illustrated herein may in some examples be omitted without departing from the scope of this disclosure Likewise, the indicated sequence of the process steps may not always be required to achieve the intended results, but is provided for ease of illustration and description. One or more of the illustrated actions, functions, or operations may be performed repeatedly and/or automated, depending on the particular strategy being used.

Finally, it will be understood that the articles and methods described herein are exemplary in nature, and that these specific examples are not to be considered in a limiting sense, because numerous variations are contemplated. Accordingly, the present disclosure includes all novel and non-obvious combinations and sub-combinations of the various systems and methods disclosed herein, as well as any and all equivalents thereof.

1. A method for processing spent energy storage and conversion devices for recycling, comprising:
obtaining a spent energy storage and conversion device that comprises packaging containing one or more cells, where each cell in the one or more cells comprises a container containing a plurality of cell components, the plurality of cell components including a positive electrode material and a negative electrode material; and
disassembling the spent energy storage and conversion device, where disassembling each spent energy storage and conversion device comprises:
opening the packaging of the spent energy storage and conversion device to expose at least a portion of the one or more cells of the spent energy storage and conversion device;
discharging the one or more cells of the spent energy storage and conversion device;
separating the one or more cells from the packaging to yield one or more individual cells; and
disassembling each cell in the one or more individual cells, where disassembling each cell comprises:
cutting the container of the cell;
separating the container from the plurality of cell components; and
separating the positive and negative electrode materials.

2. The method of claim 1, wherein the spent energy storage and conversion device includes circuitry connecting the one or more cells, where the circuitry includes a power management controller; and wherein discharging the one or more cells in the spent energy storage and conversion device includes connecting a resistor to the circuitry at such a location as to bypass the power management controller to discharge the one or more cells.

3. The method of claim 1, wherein for each spent energy storage and conversion device in the quantity of spent energy storage and conversion devices, separating the one or more cells from the packaging to yield one or more individual cells includes using a blade to cut a binding that holds a selected cell to another cell.

4. The method of claim 1, further comprising electronically sensing an orientation of the spent energy storage and conversion device and, if the spent energy storage and conversion device is not oriented in a suitable orientation for disassembly, then reorienting the spent energy storage and conversion device before disassembling the spent energy storage and conversion device.

5. The method of claim 1, cutting the container of the cell includes cutting diameter portions of opposing ends of the container and cutting a slit along a length of the container.

6. The method of claim 1, wherein cutting the container of the cell includes cutting the container via a lathe.

7. The method of claim 1, wherein each container of each cell is formed at least partially from a ferromagnetic material, and wherein separating the container from the plurality of cell components includes magnetically separating the container from the plurality of cell components.

8. The method of claim 1, wherein cutting the container of the cell comprises cutting the container via one or more multi-axis CNC devices.

9. The method of claim 1, wherein, for each cell, the positive electrode material and the negative electrode material are wound together into a wound structure; and wherein separating the positive and negative electrode material from the cell includes inserting a spindle into the wound structure and then unwinding the positive and negative electrode material with the spindle.

10. The method of claim 1, wherein, for each cell, the positive electrode material and the negative electrode material are wound together into a wound structure; and wherein separating the positive and negative electrode material from the cell includes unwinding the positive and negative electrode material by mechanically agitating the positive and negative electrode material.

11. The method of claim 1, wherein the plurality of cell components of each cell includes a current collector material, and wherein the method further comprises delaminating the positive and negative electrode materials from the current collector material.

12. The method of claim 1, wherein the plurality of cell components includes an electrolyte, and wherein the method the further comprises extracting the electrolyte from the plurality of cell components.

13. The method of claim 1, further comprising sensing an orientation of each cell and, if a selected cell is not oriented in a suitable orientation for automated disassembly, then reorienting the selected cell before disassembling the selected cell.

14. A method for processing a spent energy storage and/or conversion device for recycling, comprising:
obtaining a spent energy storage and/or conversion device, where the spent energy storage and/or conversion device includes packaging containing one or more cells and circuitry connecting the one or more cells, where the circuitry includes a power management controller;
cutting the packaging to expose at least a portion of the one or more cells; and
connecting a resistor to the circuitry to bypass the power management controller to discharge the one or more cells to a nominal voltage.

15. The method of claim 14, where the nominal voltage is a voltage less than 1.5 one volt.

16. The method of claim 14, where cutting the packaging to expose at least a portion of the one or more cells is performed by one or more multi-axis CNC devices.

17. A method for processing a spent energy storage and/or conversion device for recycling, comprising:
obtaining a spent energy storage and/or conversion device, where the spent energy storage and/or conversion device includes one or more cells, where each cell of the one or more cells comprises a container containing a plurality of cell components, and where the container is formed at least partially from a ferromagnetic material;
for each cell of the one or more cells:
cutting the container of the cell; and
magnetically separating the container from the plurality of cell components.

18. The method of claim 17, where the ferromagnetic material includes iron.

19. The method of claim 17, where each container of each cell is cylindrically-shaped and cutting the container of the cell includes cutting diameter portions of opposing ends of the container and cutting a slit along a length of the container.

20. The method of claim 17, where cutting the container of the cell is performed by one or more multi-axis CNC devices.
